(19) United States
(12) Patent Application Publication
(10) Pub. No.: US 2024/0370589 A1
(43) Pub. Date: Nov. 7, 2024

(54) IDENTIFICATION KEY GENERATION CIRCUIT BASED ON PROCESS VARIATION

(71) Applicant: IUCF-HYU (INDUSTRY-UNIVERSITY COOPERATION FOUNDATION HANYANG UNIVERSITY), Seoul (KR)

(72) Inventors: Byong Deok Choi, Seoul (KR); Jae Kyeong Jeong, Seoul (KR); Du Hyun Jeon, Seoul (KR)

(21) Appl. No.: 18/580,608

(22) PCT Filed: Jul. 19, 2022
(86) PCT No.: PCT/KR2022/010525

§ 371 Date: Jan. 18, 2024

(30) Foreign Application Priority Data
Jul. 19, 2021 (KR) 10-2021-0094492

(51) Int. Cl. G06F 21/73; H03K 17/687; H04L 9/08

(52) U.S. Cl. CPC G06F 21/73; H03K 17/6872; H04L 9/0866

(57) ABSTRACT

An identification key generation circuit using process deviation comprises a first semiconductor element portion and a second semiconductor element portion manufactured on a single semiconductor substrate and have different physical characteristics, an identification key generation portion generating an identification key using at least one of a difference in electrical characteristics of the first semiconductor element portion due to a process deviation occurring in the manufacturing process of the first semiconductor element portion and an identification key derivation portion determining the difference in electrical characteristic as a digital value, wherein the first semiconductor element portion is formed on the semiconductor substrate, and the second semiconductor element portion is formed on the upper portion of the first semiconductor element portion, and wherein the first semiconductor element portion and the second semiconductor element portion are connected to each other through at least one layer of via-holes, metal wiring, and contact hole layers.

### TECHNICAL FIELD

The present invention relates to an identification key generation circuit based on process deviation. More specifically, the present invention relates to the manufacture of a semiconductor that can improve the stability of an identification key (e.g., Physical Unclonable Function (PUF)) based on the physical characteristics of the semiconductor device in a monolithic three-dimensional semiconductor manufacturing process. The invention relates to an identification key generation circuit based on process deviation.

### BACKGROUND ART

In the field of semiconductor manufacturing technology, the performance of integrated circuits (ICs) has grown quite rapidly over the past 40 years, and in particular, the size of the components that make up integrated circuits has been scaling down as manufacturing technology has developed. down).

However, as semiconductor technology advances to the 10 nm level, miniaturization through traditional scaling down is reaching economic, physical, and technical limits.

To continue the trend of expanding semiconductor integration, which is facing these technological limitations, multilithic and monolithic 3D technologies are attracting attention from industry and academia.

Multilitic 3D technology is a technology that connects unformed silicon substrates using a through silicon via (TSV) and has the effect of significantly increasing wiring density.

Monolithic 3D technology is a vertical semiconductor technology that has multiple layers of semiconductor circuits by transferring a single crystal silicon substrate onto a substrate that has already been processed.

Monolithic 3D technology is a technology that implements vertical wiring between each layer through a lithography process.

Monolithic 3D technology has the effect of dramatically improving semiconductor integration and producing chips with superior economic efficiency and performance.

Monolithic 3D technology is similar with traditional through-silicon via (TSV) technology in that it stacks semiconductor devices upward, but the stacking method is different from TSV technology.

In other words, TSV technology is a type of assembly technology that stacks and aligns two or more independently manufactured devices (wafers), drills a hole, and connects each device through a through electrode, whereas monolithic 3D technology uses one device (wafer). This is a technology that creates 3D by stacking two or more layers of electrically conductive silicon or other materials on a wafer and repeating the process of creating different devices.

In theory, monolithic 3D technology allows for a shorter wiring process than TSV, which can improve data transfer speed, reduce the number of masks and chip area, and ultimately increase economic efficiency.

Additionally, as the importance of security technology has recently increased, the need to have a unique ID (hereinafter referred to as an identification key) for electronic devices or individual devices (or modules) that make up electronic devices has increased.

This identification key may be used as an encryption key and used in an encryption algorithm, and in some cases, the identification key may be used for various purposes other than security and authentication.

To use an identification key as a unique ID for a device or device, the digital bits that make up the generated identification key must be completely random so that the probability of being 1 or 0 is completely random.

Additionally, after the identification key is first generated, time-invariance that does not change over time must be guaranteed to a high level.

Previously, methods using hardware or software were presented as examples of methods for producing random digital values.

However, the generation of digital values through hardware or software has the problem of increasing the unit cost of chips and limitations in production speed due to the costs required for hardware and software development or production.

Therefore, there is a need for a system and method that generates and manages digital values that have low production costs, simple production processes, and cannot be copied.

In order to meet this demand, conventionally, there were several attempts to implement identification keys to be generated on devices produced on silicon wafers, such as using process variations in the CMOS (Complementary Metal-Oxide-Semiconductor) production process to create a PUF (Physically Unclonable Function).

For example, there is a method of randomly generating digital values of 0 or 1 by using process errors (mismatches) in electrical characteristics between devices produced with the same design in the same process.

Physical Uncopiable Function (PUF) refers to a technology that generates an identification key that cannot be physically copied by using differences in the physical properties or structures of semiconductors produced in the same manufacturing process.

The identification key according to the PUF contains unique information about the corresponding semiconductor device, such as fingerprint or iris information that identifies a person.

However, in the CMOS semiconductor process using a silicon wafer, even if process deviation occurs due to the crystal structure, the difference is very small.

Therefore, there was a problem in that the electrical characteristics of the semiconductor device varied depending on temperature, voltage, etc.

As a result, there was a problem that the time invariance of the PUF generated using the characteristic values of the semiconductor device is not guaranteed to a high level, and the digital value of the identification key generated from the PUF may be changed by noise, aging of the device, etc.

Additionally, there was a problem in which the PUF's identification key was stolen by an intrusion attack (e.g., topside attack or backside attack) using micro probing or reverse engineering.

To prevent such infiltration, it was necessary to use a separate intrusion attack detection circuit, which lowered the economic efficiency and ease of use of semiconductor devices.

### DISCLOSURE

### Technical Problem

Therefore, an identification key generation circuit and a memory device including the same according to an embodiment of the present invention are inventions designed to solve the problems described above.

Specifically, the present invention provides an identification key generation circuit based on process deviation that can improve the stability and time invariance of an identification key based on the physical characteristics of a semiconductor device in a monolithic three-dimensional process.

In addition, the identification key generation circuit and the device including the same according to an embodiment of the present invention has the purpose to provide an identification key generation circuit based on process deviation being capable of preventing the identification key of the PUF from being stolen by an intrusion attack (e.g., topside attack or backside attack).

The technical problems of the present invention are not limited to the technical problems mentioned above, and other technical problems not mentioned will be clearly understood by those skilled in the art from the description below.

### Technical Solution

An identification key generation circuit using process deviation according to embodiment comprises a first semiconductor element portion and a second semiconductor element portion manufactured on a single semiconductor substrate and have different physical characteristics, an identification key generation portion that generates an identification key using at least one of a difference in electrical characteristics of the first semiconductor element portion due to a process deviation occurring in the manufacturing process of the first semiconductor element portion and an identification key derivation portion that determines the difference in electrical characteristic as a digital value, wherein the first semiconductor element portion is formed on the semiconductor substrate, and the second semiconductor element portion is formed on the upper portion of the first semiconductor element portion, and wherein the first semiconductor element portion and the second semiconductor element portion are connected to each other through at least one layer of via-holes, metal wiring, and contact hole layers.
wherein the identification key derivation portion is formed from the first semiconductor element portion.
wherein the second semiconductor element portion includes a transition metal oxide containing one or more positive ions among In, Zn, Ga, and Sn.
wherein the first semiconductor element portion is produced through any one of a complementary metal oxide semiconductor manufacturing process, an amorphous silicon thin film transistor manufacturing process, and a polycrystalline silicon thin film transistor manufacturing process.
wherein the identification key generation portion includes a first transistor and a second transistor designed to the same size using the second semiconductor element portion, and
wherein the identification key generation portion generates the identification key using differences in electrical characteristics resulting from process deviations occurring in the manufacturing process of the first transistor and the second transistor.
wherein a channel layer of the first transistor includes a polycrystalline oxide thin film including at least one of IGZO, binary, three-component, four-component, and five-component system, and wherein the binary system includes at least one of ZnO, In2O3, Ga2O3, and SnO2, an wherein the three-component system includes at least one of InGaO, InZnO, GaZnO, and ZnSnO wherein the four-component system includes at least one of InGaSnO and InZnSnO, and wherein the five-component system includes InGaZnSnO.
wherein the channel layer of the first transistor has either a disordered polycrystalline thin film structure or a preferentially oriented polycrystalline thin film structure.

An identification key generation circuit using process deviation according to embodiment comprises a first semiconductor element portion and a second semiconductor element portion manufactured on a single semiconductor substrate and have different physical characteristics, an identification key generation portion that generates an identification key using at least one of a difference in electrical characteristics of the second semiconductor element portion due to a process deviation occurring in the manufacturing process of the second semiconductor element portion, a storage portion that stores the difference in electrical characteristics and an identification key derivation portion that determines the difference in electrical characteristic as a digital value using the storage portion, wherein the first semiconductor element portion is formed on the semiconductor substrate, and the second semiconductor element portion is formed on the upper portion of the first semiconductor element portion, and wherein the first semiconductor element portion and the second semiconductor element portion are connected to each other through at least one layer of via-holes, metal wiring, and contact hole layers.
wherein the identification key generation portion includes a first transistor and a second transistor designed to the same size using the second semiconductor element portion, and wherein the identification key generation portion generates the identification key using differences in electrical characteristics resulting from process deviations occurring in the manufacturing process of the first transistor and the second transistor.
wherein the manufacturing process of the second semiconductor element portion is an oxide semiconductor manufacturing process, and a manufacturing process of the first semiconductor element portion is a silicon semiconductor manufacturing process.

An identification key generation circuit using process deviation according to embodiment comprises a first transistor configured to connect a second output node and a first reference voltage to each other according to a voltage of a first output node, a second transistor configured to connect the first output node and the first reference voltage according to the voltage of the second output node, a third transistor configured to connect the second output node and a second reference voltage according to the voltage of the first output node and a fourth transistor configured to connect the first output node and the second reference voltage according to the voltage of the second output node, wherein the first transistor and the second transistor are formed through a second process, wherein the third transistor and the fourth transistor are formed through a first process, wherein the first process is one of a complementary metal oxide semiconductor manufacturing process, an amorphous silicon thin film transistor manufacturing process, and a polycrystalline silicon thin film transistor manufacturing process, wherein the second process is one of an oxide thin film transistor manufacturing process and an organic thin film transistor manufacturing process, wherein the first process is performed on a semiconductor substrate, the second process is performed above the first process, and wherein the transistor formed by the first process and the transistor formed by the second process are connected to each other through at least one layer of via-holes, metal wiring, and contact holes.

A method of generating an identification key using process deviation using a circuit that is manufactured on a single semiconductor chip and includes a first semiconductor element portion and a second semiconductor element portion having different types of physical characteristics according to embodiment comprises a step of forming the first semiconductor element portion on a semiconductor substrate, and forming the second semiconductor element portion above the first semiconductor element portion and an identification key generation step of generating an identification key using differences in electrical characteristics of the second semiconductor element portion due to process deviations occurring in the manufacturing process of the second semiconductor element portion.

The method of generating an identification key further comprises a step of storing the difference in electrical characteristics using a storage portion and a step of determining the difference in electrical characteristics as a digital value using the storage portion.

### Advantageous Effects

An identification key generation circuit based on process deviation according to an embodiment of the present invention has the effect of improving the stability and temporal invariance of an identification key based on the physical characteristics of a semiconductor device in a monolithic three-dimensional process.

In addition, the identification key generation circuit based on process deviation according to an embodiment of the present invention has the effect of preventing deodorization of the identification key of the PUF by an intrusion attack (e.g., topside attack, backside attack, or micro-probing) without a separate intrusion attack detection circuit.

The effects of the present invention are not limited to the technical problems mentioned above, and other effects not mentioned will be clearly understood by those skilled in the art from the description below.

### BRIEF DESCRIPTION OF DRAWINGS

To more fully understand the drawings cited in the detailed description of the present invention, a brief description of each drawing is provided.

FIG. 1 is a diagram showing an identification key generation circuit according to an embodiment of the present invention.

FIG. 2 is a graph showing the probability of occurrence according to a mismatch in a first semiconductor element portion and a second semiconductor element portion according to an embodiment of the present invention.

FIGS. 3(a) and 3(b) are diagrams showing a semiconductor element portion implemented as a cross-coupled inverter according to an embodiment of the present invention.

FIG. 4 is a diagram showing a semiconductor element portion implemented as a cross-coupled inverter circuit according to another embodiment of the present invention.

FIGS. 5(a) and 5(b) are diagrams showing a semiconductor element portion implemented with a NAND latch circuit according to an embodiment of the present invention.

FIG. 6 is a diagram showing a semiconductor element portion implemented with a NAND latch circuit according to another embodiment of the present invention.

FIGS. 7(a) and 7(b) are diagrams showing a semiconductor element portion implemented with a NOR latch circuit according to an embodiment of the present invention.

FIG. 8 is a diagram showing a semiconductor element portion implemented with a NOR latch circuit according to another embodiment of the present invention.

FIG. 9 is a diagram showing a semiconductor element portion implemented as a differential amplifier according to an embodiment of the present invention.

FIG. 10 is a diagram showing the structure of a semiconductor element portion according to an embodiment of the present invention.

FIG. 11 is a diagram showing a memory device according to an embodiment of the present invention.

FIG. 12 is a diagram showing a memory device according to an embodiment of the present invention.

### MODES OF THE INVENTION

Hereinafter, embodiments according to the present invention will be described with reference to the attached drawings. When adding reference signs to components in each drawing, it should be noted that the same components are given the same reference numerals as much as possible even if they are shown in different drawings.

Additionally, when describing embodiments of the present invention, if detailed descriptions of related known configurations or functions are judged to impede understanding of the embodiments of the present invention, the detailed descriptions will be omitted.

In addition, embodiments of the present invention will be described below, but the technical idea of the present invention is not limited or limited thereto and may be modified and implemented in various ways by those skilled in the art.

Throughout the specification, when a part is said to be “connected” to another part, this includes not only the case where it is “directly connected,” but also the case where it is “indirectly connected” with another element in between.

Throughout the specification, when a part is said to “include” a certain element, this means that it may further include other elements rather than excluding other elements, unless specifically stated to the contrary.

Additionally, in describing the components of the embodiment of the present invention, terms such as first, second, A, B, (a), and (b) may be used.

These terms are only used to distinguish the component from other components, and the nature, sequence, or order of the component is not limited by the term.

In other words, the present invention is not limited to the embodiments disclosed below but can be implemented in various different forms. In the description below, when a part is connected to another part, it is directly connected. In addition, it may also include cases where they are electrically connected with another element in between.

In addition, it should be noted that the same components in the drawings are indicated with the same reference numbers and symbols as much as possible, even if they are shown in different drawings.

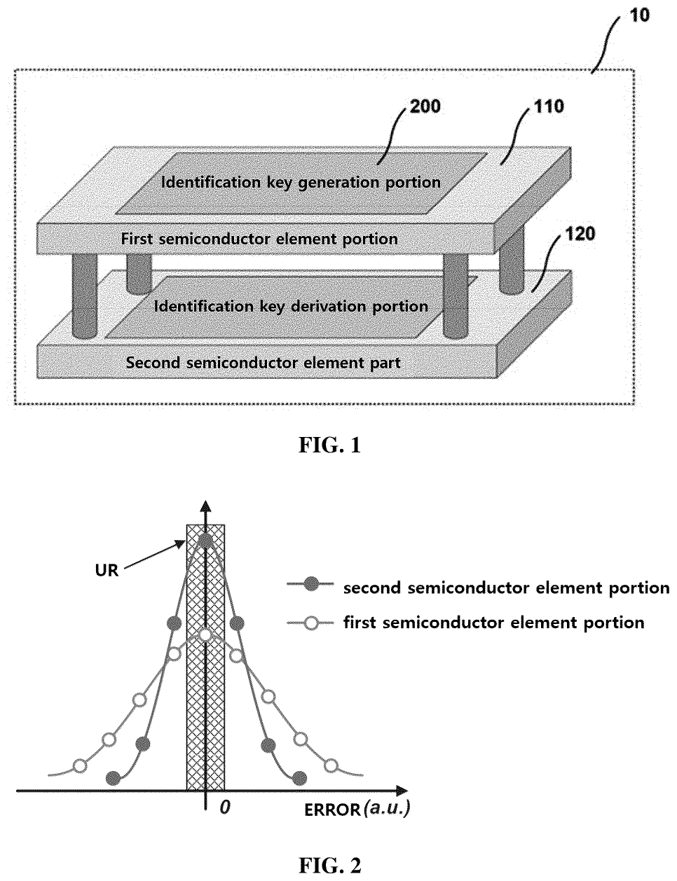

FIG. 1 is a diagram showing an identification key generation circuit 10 according to an embodiment of the present invention.

Referring to FIG. 1, the identification key generation circuit 10 may include a semiconductor element portion 100 and an identification key generation portion 200.

The semiconductor element portion 100 may include a plurality of semiconductor element portions. At this time, a plurality of semiconductor element portions is formed through a monolithic three-dimensional semiconductor manufacturing process, and each of the plurality of semiconductor devices may have unique electrical characteristics.

In other words, the identification key generation circuit 10 of the present invention is formed through a monolithic three-dimensional semiconductor manufacturing process, thereby improving data movement speed, reducing the number of masks and chip area, thereby increasing economic efficiency.

In addition, since the present invention generates an identification key using the properties of semiconductors formed by a conventional monolithic three-dimensional semiconductor manufacturing process, a separate process or separate circuit for generating the identification key may not be additionally manufactured.

The electrical characteristics of the semiconductor element portion 100 may appear different from the initially designed expected values due to limitations in semiconductor manufacturing process technology, etc.

In this specification, mismatch refers to the difference in electrical characteristics of two or more semiconductor devices designed with the same size and may have randomness.

And the process deviation represents the distribution of errors. These process deviations may appear differently depending on the semiconductor process (or structure).

That is, when semiconductor element portions are produced through a first process with a large process deviation, errors may be widely distributed, and when semiconductor element portions are produced through a second process with a small process deviation, errors may be distributed small.

Specific details related to this are explained in FIG. 2.

According to an embodiment of the present invention, a plurality of semiconductor elements included in the semiconductor element portion 100 may be designed so that a relatively large process deviation occurs in the same monolithic three-dimensional semiconductor manufacturing process.

As reviewed above, when manufacturing a semiconductor, the greater the process deviation, the greater the stability of the identification key (eg, Physically Unclonable Function (PUF)).

Therefore, the identification key generation circuit 10 of the present invention can improve the stability of the identification key based on differences in characteristics of semiconductor elements and has the effect of ensuring the time-invariant of the identification key at a high level.

More specifically, the semiconductor element portion 100 may include a first semiconductor element portion 110 and a second semiconductor element portion 120.

At this time, the first semiconductor element portion 110 and the second semiconductor element portion 120 may be formed on the same layer or different layers.

As an example, the first semiconductor element portion 110 may be formed on a first layer through a first process, and the second semiconductor element portion 120 may be formed on a second layer through a second process.

Alternatively, on the contrary, the first semiconductor element portion 110 may be formed on the second layer through a first process, and the second semiconductor element portion 120 may be formed on the first layer through a second process.

That is, the semiconductor element portion 100 of the present invention was created assuming that it has a monolithic three-dimensional structure.

Meanwhile, when the second layer is implemented as a layer different from the first layer, the first semiconductor element portion 110 and the second semiconductor element portion 120 can be electrically connected through one of a via-hole, a metal wire, and a contact hole with the above layers.

The first process deviation according to the first process may be greater than the second process deviation according to the second process.

That is, the error of the first semiconductor element portion 110 may be distributed more widely than the error of the second semiconductor element portion 120.

Details related to this are specifically explained in FIG. 2.

For example, the first process may be any one of a single crystal, polycrystalline, or amorphous semiconductor manufacturing process.

More specifically, the first process may be any one of a single crystalline indium-gallium-zinc oxide semiconductor (IGZO) manufacturing process, an oxide thin film transistor manufacturing process, and an organic thin film transistor (Organic Thin Film Transistor) manufacturing process. Film Transistor) manufacturing process.

Here, the oxide thin film transistor refers to a thin film transistor whose semiconductor layer is made of an oxide semiconductor material, and the organic thin film transistor refers to a thin film transistor whose semiconductor layer is made of an organic semiconductor material.

The oxide thin film transistor may include a transition metal oxide containing one or more cations among In, Zn, Ga, and Sn, and may have a semi conductivity with a concentration of free electrons of 1×10¹⁸ cm⁻³ or less.

These characteristics can be realized using PVD, CVD, ALD, and solution processes.

Specifically, the first process may be performed at a temperature of 500 degrees or lower, which can prevent deterioration of the lower silicon element and wiring and may include processes such as cation composition or heat treatment temperature.

Accordingly, the semiconductor may include a semiconductor channel in which the size and spatial direction distribution of crystal grains are controlled.

In addition, the semiconductor channel material may include at least one of oxide semiconductor, polycrystalline organic semiconductor, 2D layered structure (ex. MoS2, MoSe2 etc), polysilicon, and polySiGe to achieve the above purpose.

According to one embodiment, the first process may be performed during the BEOL process of the second process.

Specifically, the manufacturing process of semiconductor products (e.g., Metal-Oxide-Semiconductor Field-Effect Transistor (MOSFET)) largely consists of a wafer manufacturing process, an element manufacturing process, and finally, a packaging and testing process. Among these, the device manufacturing process may include a front end of line (FEOL) process and a back end of line (BEOL) process.

The FEOL process refers to the step of forming a MOSFET transistor on a silicon substrate.

The BEOL process refers to the step of forming metal wiring and input/output terminals for interconnection on the MOSFET transistor.

For example, the second process may be any one of a single crystal, polycrystalline, or amorphous semiconductor manufacturing process.

More specifically, the second process may be any of the complementary metal-oxide-semiconductor (CMOS) manufacturing process, the amorphous silicon thin film transistor manufacturing process, and the polycrystalline silicon thin film transistor manufacturing process.

Here, the amorphous silicon thin film transistor refers to a thin film transistor whose semiconductor layer is made of an amorphous semiconductor, and the polycrystalline silicon thin film transistor refers to a thin film transistor whose semiconductor layer is made of a polycrystalline semiconductor.

For example, the first semiconductor element portion 110 may include a first transistor having first electrical characteristics.

At this time, the first transistor may be one of an oxide thin film transistor or an organic thin film transistor.

According to an embodiment of the present invention, the first electrical characteristic may include a first threshold voltage of the first transistor.

According to an embodiment of the present invention, the channel layer of the first transistor may include a polycrystalline oxide with grain boundaries.

For example, the channel layer of the first transistor may have either a disordered polycrystalline thin film structure or a preferentially oriented polycrystalline thin film structure.

That is, the channel layer of the first transistor may have a disordered polycrystalline or preferentially oriented polycrystalline thin film structure formed by controlling the oxide cation composition and heat treatment temperature.

Additionally, according to an embodiment of the present invention, the channel layer of the first transistor may have an indium gallium oxide (InGaO) structural system, of which the indium (In) content may be 50% or more.

That is, in the present invention, by increasing the indium (In) content, the channel layer of the first transistor can have a disordered polycrystalline structure.

Depending on the indium (In) content, the process deviation of the electrical characteristics of the first transistor may increase or decrease.

In addition, the channel layer of the first transistor is made of not only IGZO, but also ZnO, In2O3, Ga2O3, SnO2, etc. as a two-component system, InGaO, InZnO, GaZnO, ZnSnO, etc. as a three-component system, InGaSnO, InZnSnO, etc. as a four-component system and InGaZnSnO, etc. as a five-component sysmem and the channel layer of the first transistor may be implemented by applying a metal catalyst (Ta, Ti, etc.) as a capping layer to promote crystallization at a low temperature of 400 degrees or less.

In addition, the Zn content in IGZO can be reduced to promote crystallinity of the channel layer of the first transistor, and the above polycrystalline oxide thin film can be realized through ALD, CVD, or solution-based process methods as well as existing sputtering methods.

Additionally, the channel layer of the first transistor according to the present invention may include either a disordered polycrystalline thin film structure or a preferentially oriented polycrystalline thin film structure.

Specifically, the present invention may include various oxide semiconductors (InO, GaO, ZnO, InGaO, InGaZnO, ZnSnO) using PVD and CVD processes of the channel layer of the first transistor.

In addition, oxide semiconductors can be implemented into random polycrystalline and highly oriented texture structures through subsequent heat treatment temperature and composition control.

More specifically, oxide semiconductors can grow random polycrystals when the indium (In) composition increases by more than 50%, and in this case, they have the characteristic of relatively increasing process deviation.

On the contrary, the oxide semiconductor can suppress crystal formation by increasing the amount of Ga by more than 50%, and in this case, it is formed in a textured or amorphous structure, thereby ensuring relatively small process deviation.

Through this, the first semiconductor element portion 110 of the present invention can have a larger process deviation than the second semiconductor element portion 120, and the identification key generation portion 200 of the identification key generation circuit 10 including the first semiconductor element portion 110 and the second semiconductor element portion 120 may generate an identification key with improved stability.

The second semiconductor element portion 120 may include a second transistor having second electrical characteristics.

At this time, the second transistor may be one of a CMOS transistor, an amorphous silicon thin film transistor, or a polycrystalline silicon thin film transistor.

According to an embodiment of the present invention, the second electrical characteristic may include a second threshold voltage of the second transistor.

The second transistor of the second semiconductor element portion 120 manufactured through the second process may have a smaller process deviation than the first transistor of the first semiconductor element portion 110 manufactured through the first process.

Meanwhile, since the first transistor and the second transistor have different device characteristics and are produced according to different processes, the first threshold voltage and the second threshold voltage may be different.

The identification key generation portion 200 may generate an identification key based on different physical characteristics of a plurality of semiconductor devices.

That is, the identification key generation portion 200 may measure the electrical characteristics (eg, threshold voltage) of the semiconductor elements and output a value representing the electrical characteristics of the semiconductor elements as an identification key.

According to one embodiment, the identification key generation portion 200 may generate an identification key using the first process deviation of the first process and the second process deviation of the second process.

That is, the identification key generation portion 200 creates an identification key with improved stability by using all of the electrical characteristics of the first and second semiconductor elements having the first and second process deviations.

According to another embodiment, the identification key generation portion 200 may generate an identification key using only the first process deviation of the first process.

That is, the identification key generation portion 200 can generate an identification key with improved stability by using the electrical characteristics of the first semiconductor elements having a first process deviation that is relatively larger than the second process deviation

Meanwhile, in FIG. 1, the identification key generation portion 200 is shown as being independently implemented by the first semiconductor element portion 110 and the second semiconductor element portion 120.

However, the present invention is not limited to this, and the first element portion 110 or the second semiconductor element portion 120 may perform the role played by the identification key generation portion 200.

That is, when the identification key generation portion 200 is implemented by the first semiconductor element portion 110 according to the first process, the first semiconductor element portion 110 plays the role of the identification key generation portion 200 described above.

In addition, when the identification key generation portion 200 is implemented by the second semiconductor element portion 120 according to the second process, the second semiconductor element portion 120 plays the role of the identification key generation portion 200 described above.

If the second semiconductor element portion 120 functions as the identification key generation portion 200, the identification key generation portion 200 may select only the second transistor according to the second process.

As a result, the identification key generation circuit 10 of the present invention can improve the stability of the identification key while securing the basic operating performance of the semiconductor element portion 100 and the identification key generation portion 200.

FIG. 2 is a graph showing the probability of occurrence of process deviation according to the error of the first semiconductor element portion 110 and the second semiconductor element portion 120 according to an embodiment of the present invention.

Referring to FIGS. 1 and 2, the first semiconductor element portion 110 is produced through a first process and may have a first process deviation.

The second semiconductor element portion 120 is produced through a second process and may have a second process deviation.

In this specification, the first process and the second process may refer to each sub-process that constitutes a monolithic 3D semiconductor manufacturing process.

In other words, the first process and the second process refer to different types of processes but can be implemented by one monolithic 3D semiconductor manufacturing process.

That is, in order to improve the stability of the identification key, the identification key generation circuit 10 of the present invention combines two different types of semiconductor devices through one semiconductor manufacturing process (for example, a monolithic 3D manufacturing process).

As shown in FIG. 2, the first process deviation of the first semiconductor element portion 110 may be greater than the second process deviation of the second semiconductor element portion 120.

The number of elements corresponding to the reference area UR among the elements of the first semiconductor element portion 110 may be less than the number of elements corresponding to the reference area UR among the elements of the second semiconductor element portion 120.

At this time, the reference area UR may mean an area in which the stability of the identification key cannot be secured.

The identification key generation circuit 10 according to an embodiment of the present invention can secure high stability of the identification key by using a semiconductor element with large process variation.

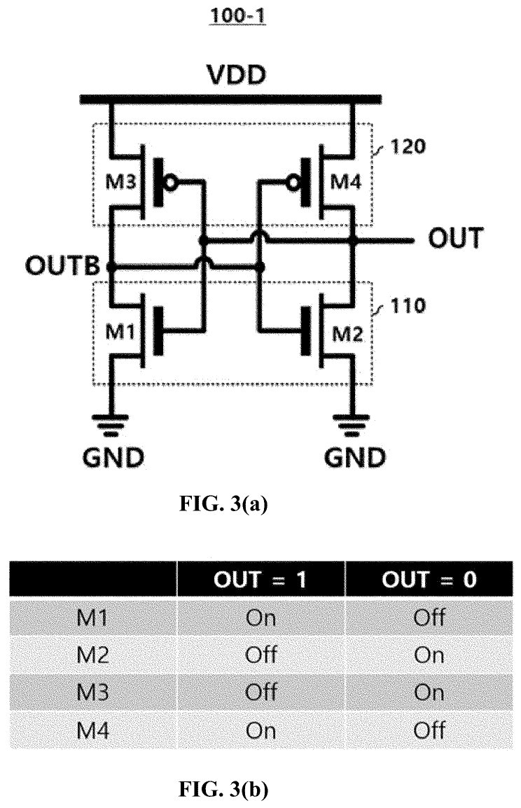

FIGS. 3(a) and 3(b) are diagrams showing a semiconductor element portion 100-1 implemented with a cross-coupled inverter circuit according to an embodiment of the present invention.

Referring to FIGS. 3(a) and 3(b), the semiconductor element portion 100-1 may include a first transistor M1, a second transistor M2, a third transistor M3, and a fourth transistor (M4).

At this time, the first transistor M1 and the second transistor M2 are included in the first semiconductor element portion 110 and can be formed through the first process, and the third transistor M3 and the fourth transistor M4 is included in the second semiconductor element portion 120 and may be formed through a second process.

The first process and the second process may be included in sub-processes included in the monolithic 3D semiconductor manufacturing process.

In FIGS. 3(a) and 3(b), the first transistor M1 and the second transistor M2 are shown as N-type transistors, and the third transistor M3 and fourth transistor M4 are shown as P-type transistors, but the present invention is limited to this.

Within the scope of achieving the purpose of the present invention, depending on the embodiment, the first transistor M1, the second transistor M2, the third transistor M3, and the fourth transistor M4 can be implemented N-type or P-type transistors.

As shown in FIG. 3(a), the first transistor M1 may connect the second output node OUTB and the first reference voltage GND according to the voltage of the first output node OUT.

The second transistor M2 may connect the first output node OUT and the first reference voltage GND according to the voltage of the second output node OUTB.

The third transistor M3 may connect the second output node OUTB and the second reference voltage VDD according to the voltage of the first output node OUT.

The fourth transistor M4 may connect the first output node OUT and the second reference voltage VDD according to the voltage of the second output node OUTB.

For example, as shown in the table of FIG. 3(b), when the voltage of the first output node OUT is the first level and the voltage of the second output node OUTB is the second level, the first transistor M1 and the fourth transistor M4 can be turned on.

When the voltage of the first output node OUT is at the second level and the voltage of the second output node OUTB is at the first level, the second transistor M2 and the third transistor M3 can be turned on.

In the above-described manner, the semiconductor element portion 100-1 according to an embodiment of the present invention can perform the function of a cross-coupled inverter.

In this specification, the first level may represent the gate-on voltage (i.e., high level) of the N-type transistor, and the second level may represent the gate-on voltage (i.e., low level) of the P-type transistor.

However, the present invention is not limited to this, and the first level and second level are relative values for each transistor and may have various values depending on the design.

In this specification, the first reference voltage GND may refer to a ground voltage, and the second reference voltage VDD may refer to a driving voltage.

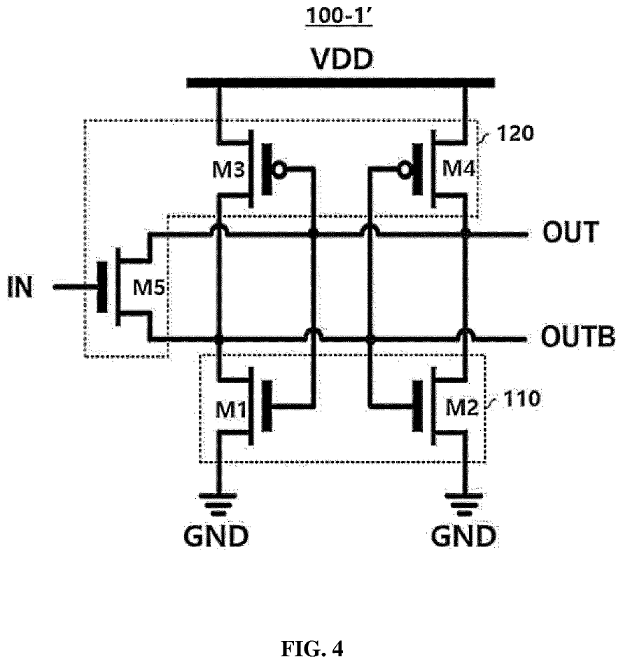

FIG. 4 is a diagram showing a semiconductor element portion 100-1′ implemented with a cross-coupled inverter circuit according to another embodiment of the present invention. To prevent duplication of explanation, the description will focus on differences from the embodiment shown in FIGS. 3(a) and 3(b).

Referring to FIGS. 3(a), 3(b) and 4, the semiconductor element portion 100-1′ may further include a fifth transistor M5 compared to the semiconductor element portion 100-1 shown in FIGS. 3(a) and 3(b).

At this time, the fifth transistor M5 is included in the second semiconductor element portion 120 and may be formed through a second process.

In FIG. 4, the fifth transistor M5 is shown as an N-type transistor, but the present invention is not limited thereto.

Within the scope of achieving the purpose of the present invention, depending on the embodiment, the fifth transistor M5 may be implemented as a P-type transistor.

The fifth transistor M5 may connect the first output node OUT and the second output node OUTB according to the voltage of the input node IN.

For example, when the voltage of the input node IN is at the first level, the fifth transistor M5 may be turned on. When the voltage of the input node IN is at the second level, the fifth transistor M5 may be turned off.

That is, depending on the voltage of the input node IN, whether the cross-coupled inverter function of the semiconductor element portion 100-1′ is performed can be controlled.

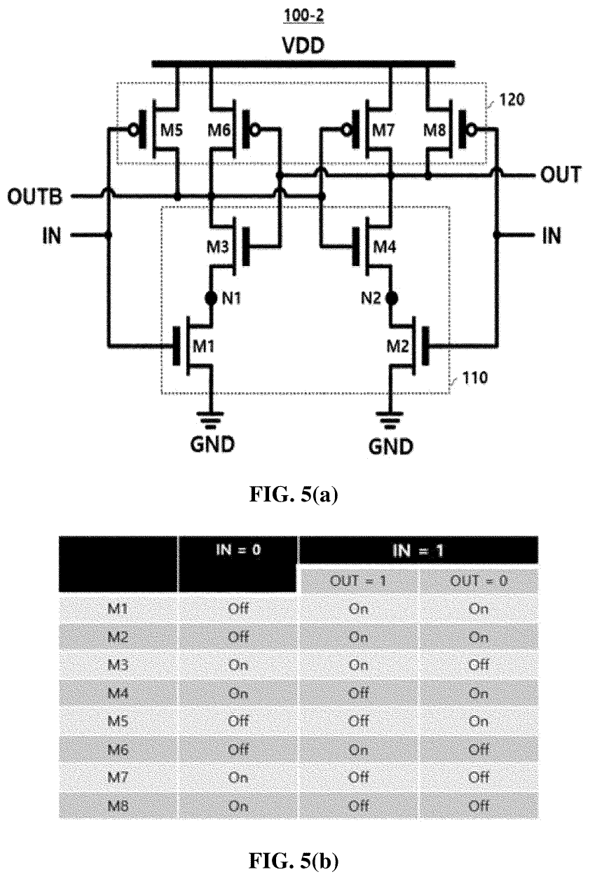

FIGS. 5(a) and 5(b) are diagrams showing a semiconductor element portion 100-2 implemented with a NAND latch circuit according to an embodiment of the present invention.

Referring to FIGS. 5(a) and 5(b), the semiconductor element portion 100-2 may include a first transistor M1, a second transistor M2, a third transistor M3, a fourth transistor M4, a fifth transistor M5, a sixth transistor M6, a seventh transistor M7, and an eighth transistor M8.

At this time, the first transistor M1 to the fourth transistor M4 are included in the first semiconductor element portion 110 and may be formed through a first process.

Additionally, the fifth to eighth transistor M5 to the eighth transistor M8 are included in the second semiconductor element portion 120 and may be formed through a second process.

The first process and the second process may refer to sub-processes included in the monolithic 3D semiconductor manufacturing process.

In FIGS. 5(a) and 5(b), the first transistor M1 to fourth transistor M4 are N-type transistors, and the fifth transistor M5 to the eighth transistor M8 are P-type transistors. However, the present invention is limited to this.

Within the scope of achieving the purpose of the present invention, depending on the embodiment, each of the first to eighth transistors M1 to M8 may be implemented as an N-type or P-type transistor.

As shown in FIG. 5(a), the first transistor M1 may connect the first node N1 and the first reference voltage GND according to the voltage of the input node IN.

The second transistor M2 may connect the second node N2 and the first reference voltage GND according to the voltage of the input node IN.

The third transistor M3 may connect the second output node OUTB and the first node N1 according to the voltage of the first output node OUT.

The fourth transistor M4 may connect the first output node OUT and the second node N2 according to the voltage of the second output node OUTB.

The fifth transistor M5 may connect the second output node OUTB and the second reference voltage VDD according to the voltage of the input node IN.

The sixth transistor M6 may connect the second output node OUTB and the second reference voltage VDD according to the voltage of the first output node OUT.

The seventh transistor M7 may connect the first output node OUT and the second reference voltage VDD according to the voltage of the second output node OUTB.

The eighth transistor M8 may connect the first output node OUT and the second reference voltage VDD according to the voltage of the input node IN.

For example, as shown in the table in FIG. 5(b), when the voltage of the input node IN is at the second level, M3, M4, M5, and M8 may be turned on.

At this time, the first output node OUT and the second output node OUTB may output a first level voltage.

When the voltage of the input node IN and the first output node OUT is at the first level and the voltage of the second output node OUTB is at the second level, M1, M2, M3 and M7 can be turned on.

When the voltage of the input node IN and the second output node OUTB is at the first level, and the voltage of the first output node OUT is at the second level, M1, M2, M4, and M6 can be turned on.

In the above-described manner, the semiconductor element portion 100-2 according to an embodiment of the present invention can perform the function of a NAND latch.

Additionally, depending on the voltage of the input node IN, whether the NAND latch of the semiconductor element portion 100-2 performs its function may be controlled.

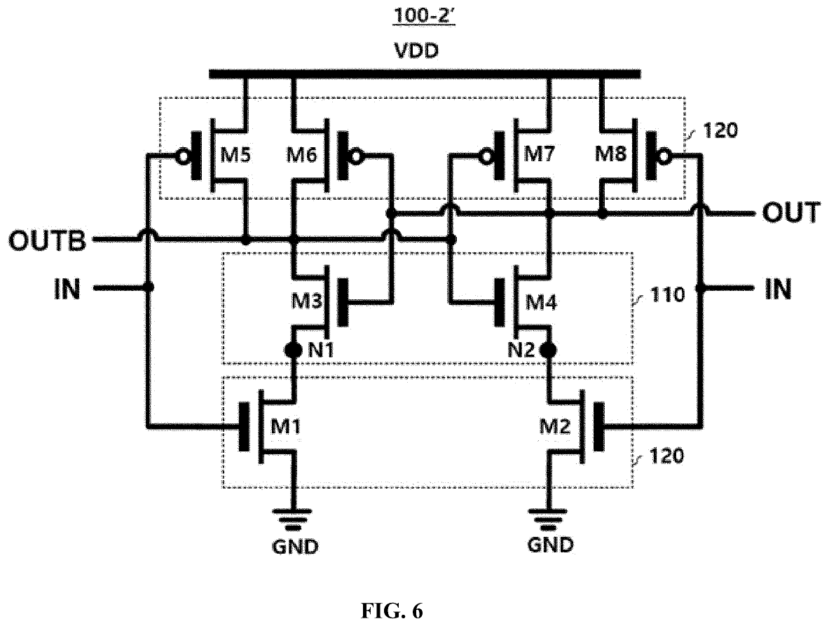

FIG. 6 is a diagram showing a semiconductor element portion 100-2′ implemented with a NAND latch circuit according to another embodiment of the present invention.

To prevent duplication of explanation, the description will focus on differences from the embodiment shown in FIGS. 5(a) and 5(b).

Referring to FIG. 6, the semiconductor element portion 100-2′ includes a first transistor (M1), a second transistor (M2), a third transistor (M3), a fourth transistor (M4), and a fifth transistor (M5), a sixth transistor (M6), a seventh transistor (M7), and an eighth transistor (M8).

At this time, the third transistor M3 and the fourth transistor M4 are included in the first semiconductor element portion 110 and may be formed through the first process.

And, the first transistor M1, the second transistor M2, the fifth transistor M5, the sixth transistor M6, the seventh transistor M7, and the eighth transistor M8 are included to the second semiconductor element portion 120 and can be formed by the second process.

The first process and the second process may refer to sub-processes included in the monolithic 3D semiconductor manufacturing process.

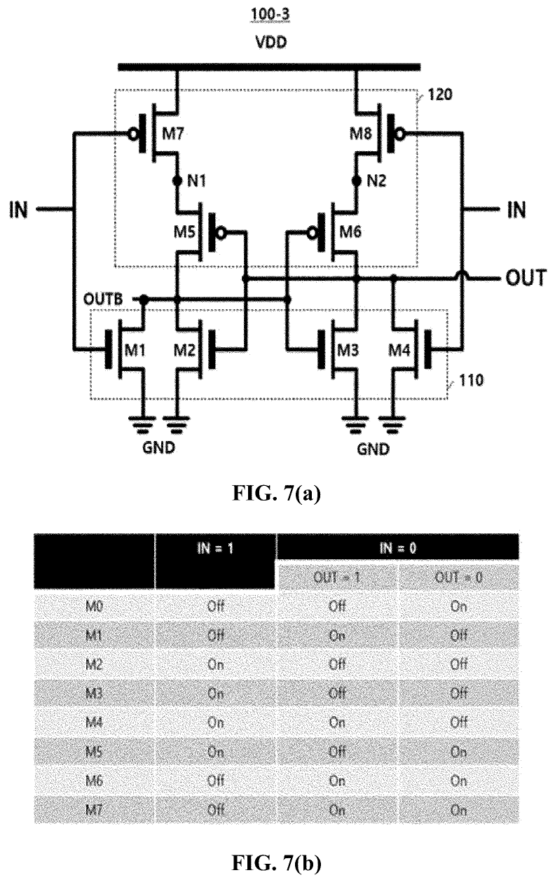

FIGS. 7(a) and 7(b) are diagrams showing the semiconductor element portion 100-3 implemented with a NOR latch circuit according to an embodiment of the present invention.

Referring to FIGS. 7(a) and 7(b), the semiconductor element portion 100-3 includes a first transistor M1, a second transistor M2, a third transistor M3, a fourth transistor M4, a fifth transistor M5, a sixth transistor M6, a seventh transistor M7, and an eighth transistor M8.

At this time, the first transistor M1 to the fourth transistor M4 may be included in the first semiconductor element portion 110 and formed through a first process.

Additionally, the fifth to eighth transistors M5 to M8 may be included in the second semiconductor element unit 120 and formed through a second process.

The first process and the second process may refer to sub-processes included in the monolithic 3D semiconductor manufacturing process.

In FIGS. 7(a) and 7(b), the first to fourth transistors M1 to M4 are shown as N-type transistors, and the fifth to eighth transistors M5 to M8 are shown as P-type transistors, but the present invention is limited to this.

Within the scope of achieving the purpose of the present invention, depending on the embodiment, each of the first to eighth transistors M1 to M8 may be implemented as an N-type or P-type transistor.

The first transistor M1 may connect the second output node OUTB and the first reference voltage GND according to the voltage of the input node IN.

The second transistor M2 may connect the second output node OUTB and the first reference voltage GND according to the voltage of the first output node OUT.

The third transistor M3 may connect the first output node OUT and the first reference voltage GND according to the voltage of the second output node OUTB.

The fourth transistor M4 may connect the first output node OUT and the first reference voltage GND according to the voltage of the input node IN.

As shown in FIG. 7(a), the fifth transistor M5 may connect the first node N1 and the second output node OUTB according to the voltage of the first output node OUT.

The sixth transistor M6 may connect the second node N2 and the first output node OUT according to the voltage of the second output node OUTB.

The seventh transistor M7 may connect the first node N1 and the second reference voltage VDD according to the voltage of the input node IN.

The eighth transistor M8 may connect the second node N2 and the second reference voltage VDD according to the voltage of the input node IN.

As shown in the table in FIG. 7(b), when the voltage of the input node IN is at the first level, the first transistor M1, the fourth transistor M4, the fifth transistor M5, and the sixth transistor M6 can be turned on.

At this time, the first output node OUT and the second output node OUTB may output a second level voltage.

When the voltage of the input node IN and the second output node OUTB is at the second level and the voltage of the first output node OUT is at the first level, the third transistor M3 and the fifth transistor M5, the seventh transistor M7 and the eighth transistor M8 may be turned on.

When the voltage of the input node IN and the first output node OUT is at the second level and the voltage of the second output node OUTB is at the first level, the second transistor M2 and the sixth transistor M6, the seventh transistor M7 and the eighth transistor M8 may be turned on.

In the above-described manner, the semiconductor element portion 100-3 according to an embodiment of the present invention can perform the function of a NOR latch.

Additionally, depending on the voltage of the input node IN, whether the NOR latch function of the semiconductor element portion 100-3 is performed may be controlled.

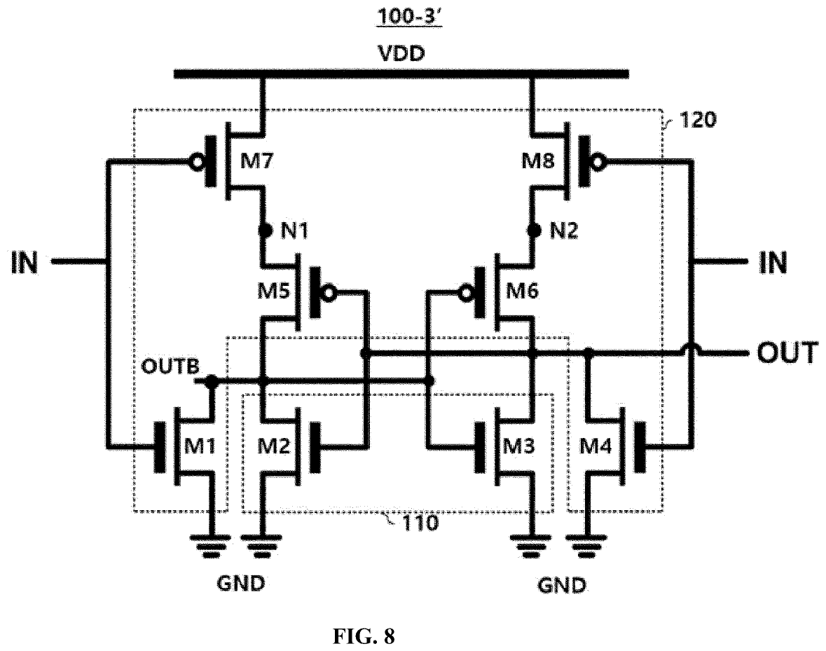

FIG. 8 is a diagram showing a semiconductor element portion 100-3′ implemented with a NOR latch circuit according to another embodiment of the present invention.

To prevent duplication of explanation, the description will focus on differences from the embodiment shown in FIGS. 7(a) and 7(b).

Referring to FIGS. 7(a) and 7(b), the semiconductor element portion 100-3′ includes a first transistor M1, a second transistor M2, a third transistor M3, a fourth transistor M4, and a fifth transistor M5, a sixth transistor M6, a seventh transistor M7, and an eighth transistor M8.

At this time, the second transistor M2 and the third transistor M3 are included in the first semiconductor element portion 110 and may be formed through the first process.

And the first transistor M1, fourth transistor M4, fifth transistor M5, sixth transistor M6, seventh transistor M7, and eighth transistor M8 are the second semiconductor element portion 120 and can be formed by the second process.

The first process and the second process may refer to sub-processes included in the monolithic 3D semiconductor manufacturing process.

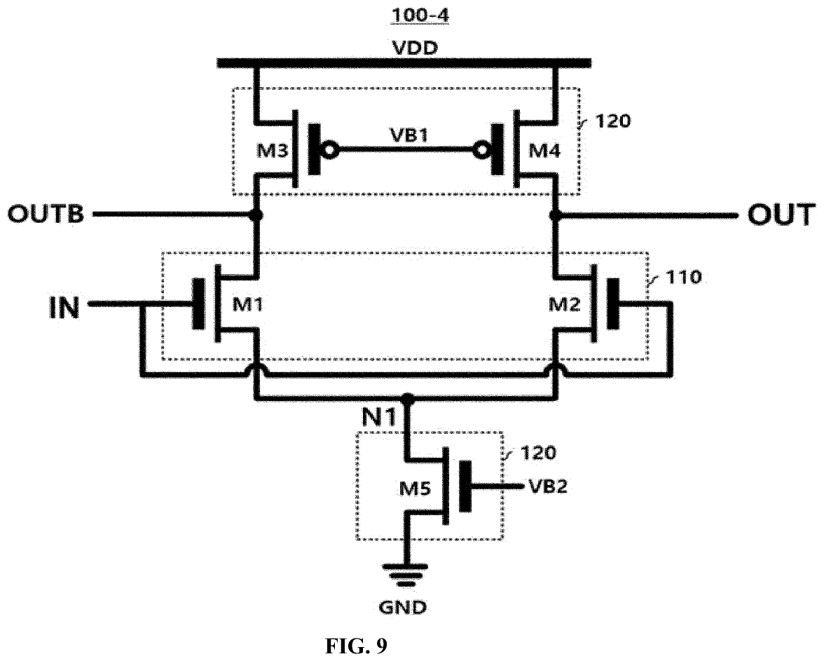

FIG. 9 is a diagram showing the semiconductor element portion 100-4 implemented as a differential amplifier according to an embodiment of the present invention.

Referring to FIG. 9, the semiconductor element portion 100-4 includes a first transistor M1, a second transistor M2, a third transistor M3, a fourth transistor M4, and a fifth transistor M5.

At this time, the first transistor M1 and the second transistor M2 may be included in the first semiconductor element portion 110 and formed through a first process.

Additionally, the third transistor M3, fourth transistor M4, and fifth transistor M5 may be included in the second semiconductor element portion 120 and formed through a second process.

The first process and the second process may refer to sub-processes included in the monolithic 3D semiconductor manufacturing process.

In FIG. 9, the first transistor M1, the second transistor M2, and the fifth transistor M5 are shown as N-type transistors, and the third transistor M3 and fourth transistor M4 are shown as P-type transistors. However, the present invention is not limited to this.

Within the scope of achieving the object of the present invention, depending on the embodiment, the first transistor M1, the second transistor M2, the third transistor M3, the fourth transistor M4, and the fifth transistor M5 respectively can be implemented with an N-type or P-type transistor.

The first transistor M1 may connect the first node N1 and the second output node OUTB according to the voltage of the input node IN.

The second transistor M2 may connect the first node N1 and the first output node OUT according to the voltage of the input node IN.

The third transistor M3 may connect the second output node OUTB and the second reference voltage VDD according to the first input voltage VB1.

The fourth transistor M4 may connect the first output node OUT and the second reference voltage VDD according to the voltage of the first input voltage VB1.

The fifth transistor M5 may connect the first node N1 and the first reference voltage GND according to the second input voltage VB2.

Through the above-described structure, the semiconductor element portion 100-4 according to an embodiment of the present invention can perform the function of a differential amplifier.

Additionally, depending on the voltage of the input node IN, whether the differential amplifier of the semiconductor element portion 100-4 performs the function may be controlled.

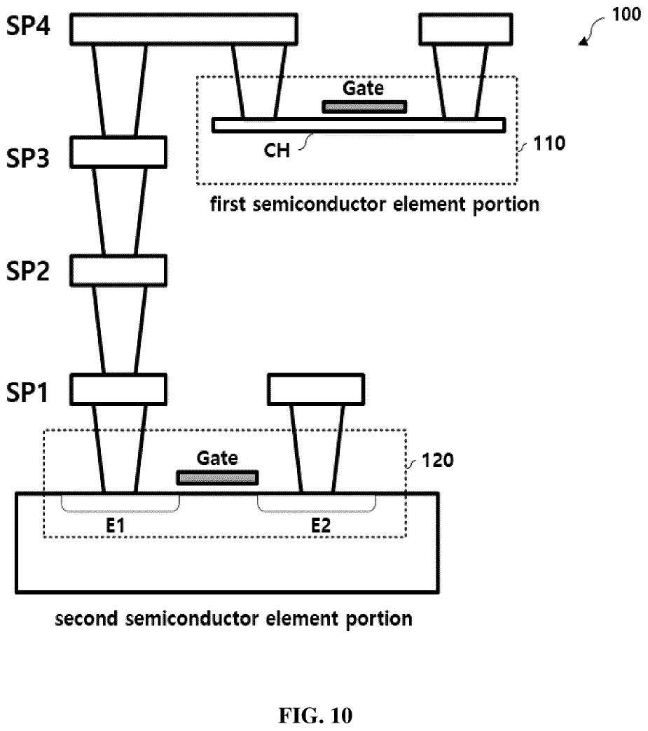

FIG. 10 is a diagram showing the structure of the semiconductor element portion 100 according to an embodiment of the present invention.

Referring to FIG. 10, the semiconductor element portion 100 may be produced according to a monolithic three-dimensional semiconductor manufacturing process, and the semiconductor element portion 100 may have a structure in which multiple layers are stacked in the vertical direction.

And the monolithic three-dimensional semiconductor manufacturing process of the semiconductor element portion 100 includes a first sub-process SP1, a second sub-process SP2, a third sub-process SP3, and a fourth sub-process SP4 corresponding to each layer.

However, the present invention is not limited to this, and the manufacturing process of the semiconductor element portion 100 of the present invention may include a various number of sub-processes.

The first sub-process SP1 is a process of forming a semiconductor element on a base substrate and may include a second process in which the second semiconductor element portion 120 is formed.

According to one embodiment, the second semiconductor element portion 120 may include a transistor connecting the first electrode E1 and the second electrode E2 according to the voltage applied to the gate electrode GE.

The second sub-process SP2 may be a process of forming a semiconductor element on the layer formed by the first sub-process SP1.

The third sub-process SP3 may be a process of forming a semiconductor element on the layer formed by the second sub-process SP2.

The fourth sub-process SP4 is a process of forming a semiconductor element on the layer formed by the third sub-process SP3 and may include a first process in which the first semiconductor element portion 110 is formed.

According to one embodiment, the first semiconductor element portion 110 may include a transistor being formed a channel in the channel layer CH (e.g., semiconductor layer) according to the voltage applied to the top gate electrode TGE and the bottom gate electrode BGE.

In FIG. 10, the first process is shown as being performed by being included in the fourth sub-process SP4, but the present invention is not limited thereto.

Depending on the embodiment, the first process may be performed by being included in the first to third sub-processes SP1 to SP3 or the fifth or more sub-processes.

Additionally, depending on the embodiment, the first process may be performed over two or more sub-processes.

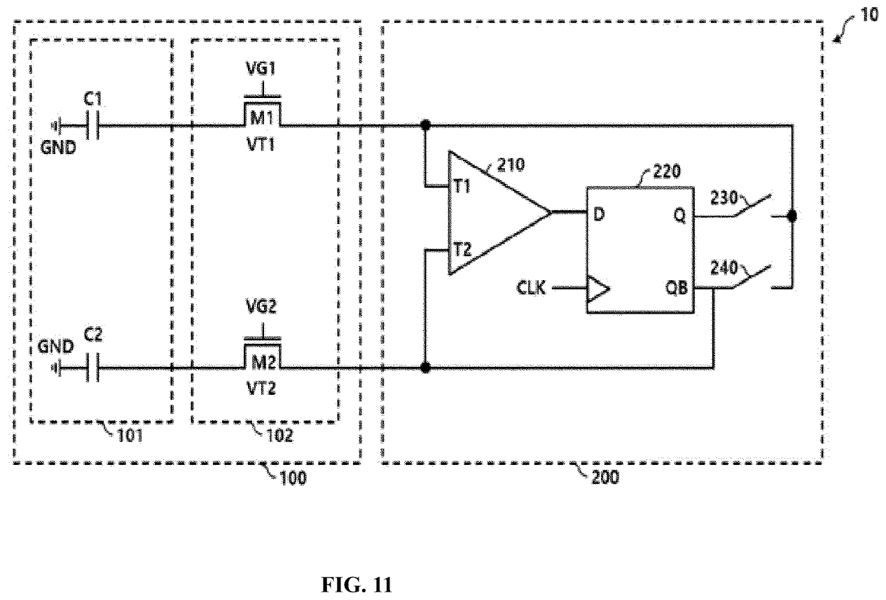

FIG. 11 is a diagram showing an identification key generation circuit 10 according to an embodiment of the present invention.

Referring to FIG. 11, according to an embodiment of the present invention, the identification key generation circuit 10 adopt an oxide thin film transistor with a very small leakage current (10\hat{ }(−24) level) as a DRAM (Dynamic Random Access Memory) transistor, can be implemented as a non-volatile DRAM PUF.

The identification key generation circuit 10 according to an embodiment of the present invention may generate an identification key based on process deviations of semiconductor devices formed through a monolithic 3D semiconductor manufacturing process.

To this end, the identification key generation circuit 10 may include a semiconductor element portion 100 and an identification key generation portion 200.

The semiconductor element portion 100 is formed through a first process and may include a storage portion 101 and a first semiconductor element portion 110.

The storage portion 101 may include a first capacitor C1 and a second capacitor C2 generated through a first process.

The first capacitor C1 may be connected to one end of the first transistor M1, and the second capacitor C2 may be connected to one end of the second transistor M2.

For example, the PUF may be determined depending on the amount of charge in each of the first capacitor C1 and the second capacitor C2.

If the amount of charge charged in the first capacitor is greater than the amount of charge charged in the second capacitor, the corresponding PUF may indicate 1, and if the amount of charge charged in the second capacitor is greater than the amount of charge charged in the first capacitor, the corresponding PUF may indicate 0.

According to one embodiment, when the storage portion 101 includes capacitors C1 and C2, the PUF value may change when the charge stored in the capacitors C1 and C2 is charged or discharged.

Therefore, the present invention has the effect of improving the stability and security of the PUF by being able to flexibly respond to intrusion attacks from the outside.

However, the present invention is not limited to this and may be implemented in reverse depending on the embodiment.

Details related to this are explained below.

The first semiconductor element portion 110 may include a first transistor M1 and a second transistor M2 produced through a first process.

At this time, the first transistor M1 may have a first threshold voltage VT1, and the second transistor M2 may have a second threshold voltage VT2.

For convenience of explanation, it is assumed that the first transistor M1 and the second transistor M2 are N-type transistors, but the present invention is not limited thereto.

Depending on the embodiment, each of the first transistor M1 and the second transistor M2 may be implemented as an N-type or P-type transistor.

As described above, the threshold voltage of the transistor may have an error where the expected value and the actual value are different during initial design, so even though the first transistor and the second transistor are generated through the same first process, the first threshold voltage VT1 and the second threshold voltage VT2 may be different.

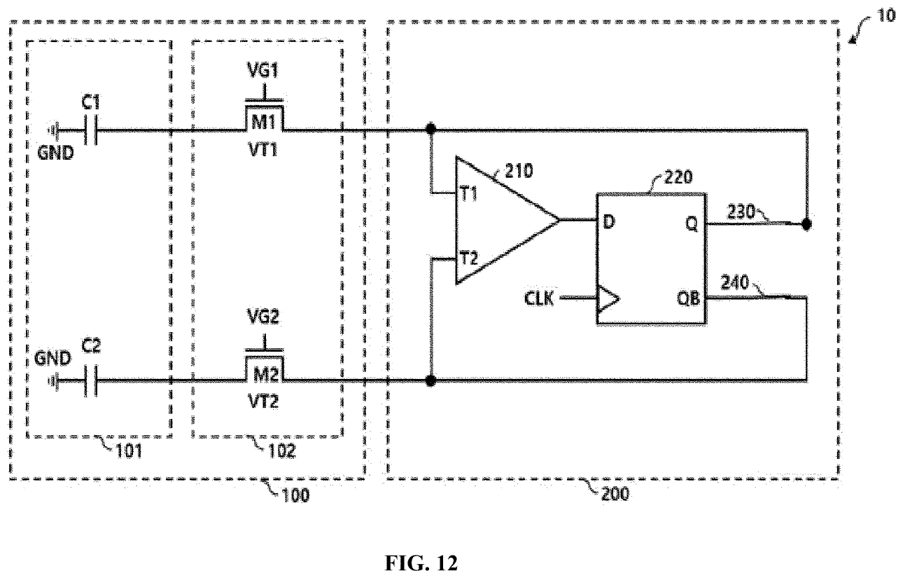

FIGS. 11 and 12 are diagrams showing a memory device according to an embodiment of the present invention.

The identification key generation portion 200 is formed through a second process and can generate an identification key based on different physical characteristics of a plurality of semiconductor devices.

For example, the first process deviation according to the first process may be greater than the second process deviation according to the second process.

FIGS. 11 and 12 are diagrams showing a memory device according to an embodiment of the present invention.

For example, the identification key generator 200 may include a comparator 210, a D flip-flop 220, a first switch 230, and a second switch 240.

The comparator 210 can compare the charge difference between the first capacitor C1 and the second capacitor C2 connected through switches M1 and M2.

The voltage across the capacitor is determined depending on the size of the capacitance and the amount of charge charged, and the comparator compares the size of this voltage to compare which capacitor among the first capacitor and the second capacitor has more charge.

The D flip-flop 220 may store the output value of the comparator 210 and transmit the first output Q and the second output QB to the semiconductor element portion 100 by synchronizing with the clock signal CLK.

The first switch 230 and the second switch 240 are disposed between the D flip-flop 220 and the semiconductor element unit 100 to control transmission of the first output Q and the second output QB.

According to an embodiment of the present invention, the first process may be an oxide semiconductor manufacturing process, and the second process may be a silicon semiconductor manufacturing process.

Below, the operation of the identification key generation circuit 10 implemented with a non-volatile DRAM PUF is described in detail.

In the pre-charge section (i.e., the first section), the first output Q of the D flip-flop 220 may have a second level, and the second output QB may have a first level.

At this time, the first level may represent the driving voltage and logic 1, and the second level may represent the ground voltage and logic 0.

However, the present invention is not limited to this, and the first level and second level are relative values for each transistor and may have various values depending on the design.

Additionally, the first switch 230 may be open and the second switch 240 may be short-circuited.

Additionally, the first gate voltage VG1 of the first transistor M1 and the second gate voltage VG2 of the second transistor M2 may have a value greater than the threshold voltage or driving voltage.

Accordingly, the first transistor M1 and the second transistor M2 can be turned on. As a result, the second output QB of the D flip-flop 220 is applied to the first capacitor C1 and the second capacitor C2, and the charge corresponding to the driving voltage can be charged to the first capacitor C1 and the second capacitor C2.

In the evaluation section (i.e., the second section), the first switch 230 and the second switch 240 may be opened. Additionally, the first gate voltage VG1 of the first transistor M1 and the second gate voltage VG2 of the second transistor M2 may have the same value as the driving voltage.

Accordingly, the difference between the driving voltage and the first threshold voltage VT1 is input to the first input terminal T1 of the comparator 210, and the difference between the driving voltage and the second threshold voltage VT2 is input to the second input terminal T2.

As a result, the first output Q and second output QB values of the D flip-flop 220 may be determined according to the magnitude of the first threshold voltage VT1 and the second threshold voltage VT2.

For example, when the first threshold voltage VT1 is greater than the second threshold voltage VT2, the first output Q has a second level, and the second output QB has a first level.

Meanwhile, when the second threshold voltage VT2 is greater than the size of the first threshold voltage VT1, the first output Q may have a first level and the second output QB may have a second level.

In the enrollment section (i.e., the third section), the first switch 230 and the second switch 240 may be short-circuited.

The first gate voltage VG1 of the first transistor M1 and the second gate voltage VG2 of the second transistor M2 may have the same value as the driving voltage.

Accordingly, the first output Q of the D flip-flop 220 may be applied to the first capacitor C1, and the second output QB may be applied to the second capacitor C2.

As a result, the first capacitor C1 and the second capacitor C2 can store the identification key value based on the threshold voltage of the semiconductor element.

For example, when the first threshold voltage VT1 is greater than the second threshold voltage VT2, the first capacitor C1 stores the second level voltage, and the second capacitor C2 stores the first level voltage.

Meanwhile, when the second threshold voltage VT2 is larger than the first threshold voltage VT1, the first capacitor C1 stores the first level voltage, and the second capacitor C2 stores the second level voltage.

The identification key generation circuit 10 according to an embodiment of the present invention is i) when a backside attack occurs, electrostatic charges are generated in the Substrate FIB Trench process, and a change in the amount of charge stored in the capacitor of the storage portion 101 occurs. Therefore, the identification key value may be lost.

In addition, the identification key generation circuit 10 is ii) when a topside attack occurs, electrostatic charges are generated during the top-metal polishing process and a change in the amount of charge stored in the capacitor of the storage portion 101 occurs, so the identification key value may be lost.

In addition, if the identification key generation circuit 10 is infiltrated by iii) micro-probing, the capacitor charge of the storage portion101 may be discharged during the micro-probing process, and the identification key value may be lost.

As a result, the identification key generation circuit 10 can improve security performance by detecting intrusion without a separate intrusion attack detection circuit and preventing the identification key value from being leaked.

According to the above-described method, the identification key generation circuit based on process deviation according to an embodiment of the present invention has an effect that improving the stability and time invariance of the identification key based on the physical characteristics of the semiconductor device in a monolithic three-dimensional process.

In addition, the identification key generation circuit based on process deviation according to an embodiment of the present invention generates the identification key of the PUF by an intrusion attack (e.g., topside attack, backside attack, or micro-probing) without a separate intrusion attack detection circuit. It has the effect of preventing deodorization.

The present description sets forth the best mode of the invention and provides examples to illustrate the invention and to enable any person skilled in the art to make or use the invention. The specification prepared in this way does not limit the present invention to the specific terms presented.

Although the present invention has been described above with reference to preferred embodiments, those skilled in the art or have ordinary knowledge in the relevant technical field should not deviate from the spirit and technical scope of the present invention as set forth in the claims to be described later. It will be understood that the present invention can be modified and changed in various ways within the scope not permitted.

Therefore, the technical scope of the present invention should not be limited to what is described in the detailed description of the specification, but should be determined by the scope of the patent claims.

1. An identification key generation circuit using process deviation comprising:
a first semiconductor element portion and a second semiconductor element portion manufactured on a single semiconductor substrate and have different physical characteristics;
an identification key generation portion that generates an identification key using at least one of a difference in electrical characteristics of the first semiconductor element portion due to a process deviation occurring in the manufacturing process of the first semiconductor element portion; and
an identification key derivation portion that determines the difference in electrical characteristic as a digital value;
wherein the first semiconductor element portion is formed on the semiconductor substrate, and the second semiconductor element portion is formed on the upper portion of the first semiconductor element portion, and
wherein the first semiconductor element portion and the second semiconductor element portion are connected to each other through at least one layer of via-holes, metal wiring, and contact hole layers.

2. The identification key generation circuit using process deviation according to claim 1,
wherein the identification key derivation portion is formed from the first semiconductor element portion.

3. The identification key generation circuit using process deviation according to claim 1,
wherein the second semiconductor element portion includes a transition metal oxide containing one or more positive ions among In, Zn, Ga, and Sn.

4. The identification key generation circuit using process deviation according to claim 1,
wherein the first semiconductor element portion is produced through any one of a complementary metal oxide semiconductor manufacturing process, an amorphous silicon thin film transistor manufacturing process, and a polycrystalline silicon thin film transistor manufacturing process.

5. The identification key generation circuit using process deviation according to claim 1,
wherein the identification key generation portion includes a first transistor and a second transistor designed to the same size using the second semiconductor element portion, and
wherein the identification key generation portion generates the identification key using differences in electrical characteristics resulting from process deviations occurring in the manufacturing process of the first transistor and the second transistor.

6. The identification key generation circuit using process deviation according to claim 5,
wherein a channel layer of the first transistor includes a polycrystalline oxide thin film including at least one of IGZO, binary, three-component, four-component, and five-component system, and
wherein the binary system includes at least one of ZnO, In2O3, Ga2O3, and SnO2, and
wherein the three-component system includes at least one of InGaO, InZnO, GaZnO, and ZnSnO,
wherein the four-component system includes at least one of InGaSnO and InZnSnO, and
wherein the five-component system includes InGaZnSnO.

7. The identification key generation circuit using process deviation according to claim 6,
wherein the channel layer of the first transistor has either a disordered polycrystalline thin film structure or a preferentially oriented polycrystalline thin film structure.

8. An identification key generation circuit using process deviation comprising:
a first semiconductor element portion and a second semiconductor element portion manufactured on a single semiconductor substrate and have different physical characteristics;
an identification key generation portion that generates an identification key using at least one of a difference in electrical characteristics of the second semiconductor element portion due to a process deviation occurring in the manufacturing process of the second semiconductor element portion;
a storage portion that stores the difference in electrical characteristics; and
an identification key derivation portion that determines the difference in electrical characteristic as a digital value using the storage portion;
wherein the first semiconductor element portion is formed on the semiconductor substrate, and the second semiconductor element portion is formed on the upper portion of the first semiconductor element portion, and
wherein the first semiconductor element portion and the second semiconductor element portion are connected to each other through at least one layer of via-holes, metal wiring, and contact hole layers.

9. The identification key generation circuit using process deviation according to claim 8,
wherein the identification key generation portion includes a first transistor and a second transistor designed to the same size using the second semiconductor element portion, and
wherein the identification key generation portion generates the identification key using differences in electrical characteristics resulting from process deviations occurring in the manufacturing process of the first transistor and the second transistor.

10. The identification key generation circuit using process deviation according to claim 9,
wherein the manufacturing process of the second semiconductor element portion is an oxide semiconductor manufacturing process, and a manufacturing process of the first semiconductor element portion is a silicon semiconductor manufacturing process.

11. An identification key generation circuit using process deviation comprising:
a first transistor configured to connect a second output node and a first reference voltage to each other according to a voltage of a first output node;
a second transistor configured to connect the first output node and the first reference voltage according to the voltage of the second output node;
a third transistor configured to connect the second output node and a second reference voltage according to the voltage of the first output node; and
a fourth transistor configured to connect the first output node and the second reference voltage according to the voltage of the second output node;
wherein the first transistor and the second transistor are formed through a second process,
wherein the third transistor and the fourth transistor are formed through a first process,
wherein the first process is one of a complementary metal oxide semiconductor manufacturing process, an amorphous silicon thin film transistor manufacturing process, and a polycrystalline silicon thin film transistor manufacturing process,
wherein the second process is one of an oxide thin film transistor manufacturing process and an organic thin film transistor manufacturing process,
wherein the first process is performed on a semiconductor substrate, the second process is performed above the first process, and
wherein the transistor formed by the first process and the transistor formed by the second process are connected to each other through at least one layer of via-holes, metal wiring, and contact holes.

12. A method of generating an identification key using process deviation using a circuit that is manufactured on a single semiconductor chip and includes a first semiconductor element portion and a second semiconductor element portion having different types of physical characteristics comprising:
a step of forming the first semiconductor element portion on a semiconductor substrate, and forming the second semiconductor element portion above the first semiconductor element portion; and
an identification key generation step of generating an identification key using differences in electrical characteristics of the second semiconductor element portion due to process deviations occurring in the manufacturing process of the second semiconductor element portion.

13. The method of generating an identification key using process deviation according to claim 12, further comprising
a step of storing the difference in electrical characteristics using a storage portion; and
a step of determining the difference in electrical characteristics as a digital value using the storage portion.
